(19) United States
(12) Patent Application Publication
(10) Pub. No.: US 2011/0148861 A1
(43) Pub. Date: Jun. 23, 2011

(54) PET DATA PROCESSING SYSTEM, AN ARRANGEMENT, A METHOD AND A COMPUTER PROGRAM PRODUCT FOR DETERMINING A DISTRIBUTION OF A TRACER UPTAKE

(75) Inventor: Ronald Boellaard, Amsterdam (NL)

(73) Assignee: VERENIGING VOOR CHRISTELIJK HOGER ONDERWIJS, WETENSCHAPPELIJK, Amsterdam (NL)

(21) Appl. No.: 12/937,223

(22) PCT Filed: Apr. 8, 2008
(86) PCT No.: PCT/NL2008/050195

§ 371 Date: Jan. 3, 2011

(51) Int. Cl. G06K 9/00; G06T 11/20

(52) U.S. Cl. 345/419; 382/131; 345/440

(57) ABSTRACT

The invention relates to a data processing system 2 for determining a distribution of a tracer uptake, comprising image processing means 4 arranged for scoring partial volumes of the target region from one or more PET images comprising a suitable target region as a function of parameter values representative of a tracer uptake in said partial volumes. The data processing system 2 further comprises computing means 6 arranged for determining a distribution of said partial volumes over said parameter values. For this purpose, first, the computing means may be arranged to determine a range of the parameter values. Secondly, the computing means may be arranged to compute relative (percentage) parameter values with respect to the maximum parameter value identified in the range. Thirdly, the computing means may be arranged to relate the partial volumes having substantially the same parameter value or relative parameter value with said parameter values. Preferably, such relation is stored in a memory unit 7 as a cumulative or binned histogram. The invention further relates to an arrangement comprising the data processing system 2 and a PET scanner 1. The invention still further relates to a method and a computer program product for determining a distribution of a tracer uptake.

### FIELD

The invention relates to a data processing system, in particular, to a PET data processing system arranged for determining a distribution of a tracer in a target region. The invention further relates to an arrangement comprising a data processing system, a method for analyzing a distribution of a tracer uptake and a computer program product for enabling the same.

### BACKGROUND

Positron Emission Tomography (PET) is a per se known diagnostic medical imaging technique, which is used to determine the distribution of a (radio-)tracer in vivo. Uptake of that tracer can be determined quantitatively in a target region, for example in a tumor. For this purpose a suitable amount of a radioactive tracer element is introduced into a patient under investigation. When a sufficient time has elapsed, allowing for accumulation of the tracer in and over the body and in one or more target regions (e.g. tumors) of the patient, the latter is subjected to a scanning procedure using a PET of PET/CT scanner. The PET or PET/CT scanner usually comprises a large number of detector elements conceived to detect coincident annihilation photons, which are generated from annihilation of a positron in tissue. The positron is emitted by the radiotracer in the body of the patient. By utilizing suitable image reconstruction methods, the thus detected coincident photons are used to reconstruct an image representing the distribution of the radiotracer in the patient. These images provide quantitative data for analysis of a tracer uptake and it's distribution in a target volume of interest.

Quantification of radiopharmaceutical (radio-tracer) uptake by the target volume is usually performed using standardized uptake values (SUV). An embodiment of such method is described in Boellaard R. et al “Effects of noise, image resolution, and ROI definition on the accuracy of standard uptake values: a simulation study”, The Journal of Nuclear Medicine, Vol. 45, No. 9, pp 1519-1527, 2004. A first step in determining SUV is to derive the activity concentration (AC) in the tumor. Usually, the AC is obtained by placing a 2D or 3D region of interest (ROI) over the tumor either visually, automatically using a threshold value or using a fixed size ROI. This results in obtaining an overall homogenized AC value for the whole ROI. Alternatively, the maximum pixel value within the ROI is used to quantify the uptake of the tracer. As a result, a single SUV value is derived to assess the tracer uptake within the ROI.

It is a disadvantage of the method known in the art, that either a homogenized value of the uptake or a single maximum value of the uptake are used to characterize the three-dimensional tracer uptake in the ROI. The known approach, therefore, may lead to erroneous data interpretation and inadequate leveling of possible inhomogeneous uptake in the ROI.

### SUMMARY OF THE INVENTION

In is an object of the invention to provide a data processing system for determining a distribution of a tracer in a target region, taking into account inhomogeneous character of a tracer uptake.

To this end the data processing system according to the invention comprises:
image processing means for scoring partial volumes of the target region from one or more PET images comprising the target region as a function of parameter values representative of a tracer uptake in said partial volumes;
computing means for determining a distribution of said partial volumes over said parameter values.

The technical measure of the invention is based on the insight that heterogeneity of the tracer uptake can be easily, accurately and reliably deduced by scoring partial volumes of the target region having substantially the same parameter value, for example, a tracer uptake or a standardized uptake value, and by setting off these partial volumes as a function of the parameter value. In this way a curve may be provided representing a distribution of the partial volumes having the same parameter value of the range of the parameter values. Examples of such curves will be discussed in more detail with reference to Figures.

In this way a disadvantage of the method known in the art is overcome by providing accurate information about the distribution of the tracer within the target region. It will be appreciated that the target region may be defined as a suitable ROI manually, or, preferably, using per se known image segmentation and/or image registration methods. The provision of information pertaining to the distribution of the tracer in the ROI, it is possible not only to accurately study a tumor uptake, but also to accurately study any heterogeneity in the tumor uptake, and also by providing data on a local heterogeneous tumor response to a suitable treatment.

In an embodiment of the data processing system according to the invention the computer means is arranged for determining a cumulative or a binned distribution of said partial volumes over said parameter values.

In some cases, it may be preferable to provide a cumulative distribution of the partial volumes having the same parameter value over a range of parameter values. The cumulative distribution may be seen as a histogram which presents a total relative (percentage) partial volume having a parameter value greater than a certain pre-set relative parameter threshold as a function of that relative parameter threshold. The binned distribution shows a total relative (percentage) partial volume per parameter value, binned using a user- or system specified step size, as a function of a running parameter value, which is relative to the maximum parameter value.

In a further embodiment of the data processing system according to the invention the system further comprises correction means for correcting the one or more PET images for partial volume effects of a PET or PET/CT scanner.

It is found that in some cases particularly cumulative distribution may suffer from data inconsistencies caused by imperfections of a response of a PET or PET/CT scanner. Contemporarily, clinical PET and/or PET/CT scanners typically have an image resolution of about 3 to 7 mm full width at half maximum. Such relatively low resolution may result in a non-homogeneous distribution of image pixel- or voxel values even for phantoms having homogeneous distribution. This phenomenon is usually called a Partial Volume Effect (PVE). In accordance with the technical measure of the invention, in order to further improve accuracy and reliability of assessment of tracer uptake heterogeneity, the PET images are subjected to PVE correction prior to performing scoring of partial volumes having substantially the same parameter value. A plurality of per se known techniques used for PVE correction may be applied. For example, partial volume correction technique, known from Brix et al “Use of scanner characteristics in iterative image reconstruction for high-resolution positron emission tomography studies of small animals”, European Journal of Nuclear Medicine, Vol. 24 No. 7, 1997, or a 3D-space convolution technique, known from Reader A. J. et al “EM algorithm system modeling by image-space techniques for PET reconstruction”, IEEE Transactions on Nuclear Medicine, Vo. 50, No. 5, 2003 may be used. It will be appreciated that a great variety of applicable computational algorithms is present for partial volume correction of PET studies, for this reason the named examples may not be construed in a limitative way. Alternatively or additionally, it is possible to carry out necessary image based corrections for PVE effects by normalizing an observed non-PVE-corrected cumulative partial volume distribution with a distribution of a same region obtained based on a theoretical homogeneous uptake.

In a further embodiment of the data processing system according to the invention the correction means is arranged to use a prior knowledge about properties of the PET scanner for said correction.

Preferably, for such prior knowledge detector and scanner resolution is used and, optionally, data on range of the annihilation photons in the detector's material and data on range of positrons of the tracer element in tissue.

In a further embodiment of the data processing system according to the invention said one or more PET images comprise images acquired prior to and post a specified event.

It is found to be particularly advantageous to apply analysis of a heterogeneous uptake to evaluating a success of a treatment. In this way, in order to validate whether a treatment, like chemotherapy, is sensible, it is possible to perform an initial PET scan prior to treatment and post some few chemotherapeutic sessions. By comparing cumulative or binned distributions of the partial volumes having the same tracer uptake, it is possible to decide whether chemotherapeutic treatment has any effect. This may be of a paramount importance for wellness of the patient, as it is widely acknowledged that chemotherapy has a pronounced systemic toxicity, which should be avoided in case when such treatment has little or non effect regarding the target region.

In a further embodiment of the data processing system according to the invention, the processing means is arranged to determine a maximum volume of the target region over said prior to and post event images,
the data processing system further comprising registration means for registering individual target regions corresponding to individual PET images from said prior to and post images with the maximum region volume yielding registered regions;
the computing means being further arranged to:
   i. calculate weighted partial volumes with respect to the maximal volume of the target region;
   ii. determine a distribution of said weighted partial volumes over said parameter values, preferably for determining said binned or said cumulative distributions.

In some cases it might be preferable to link the images of the target region acquired prior to or post some event. It will be appreciated that within the terms of the present invention ‘the event’ may not only relate to a treatment, but also to a recovery or observation period, characterized by elapsing of a certain time.

In accordance with the present embodiment, image data comprising the target region are acquired prior to and post the event, for example prior to and post suitable treatment. After this, the target region may be suitably delineated manually or using automated registration techniques yielding target regionₚᵣᵢₒᵣ and target regionₚₒₛₜ. A maximum target region volume is then determined and respective partial volumes originated from the images prior to and post the event are normalized with respect to the maximum volume. Finally, binned or cumulative distributions of such weighted partial volumes may be presented. This way of linking the distributions may be advantageous particularly in situations when next to evaluating dynamics in the uptake heterogeneity any dynamics in total volume of the target region is also studied.

In a further embodiment of the data processing system the computing means is arranged to:
determine a maximum parameter value for all images;
calculate a weighted threshold parameter values in dependence of the maximum parameter value;
determine a distribution of said partial volumes over said weighted threshold parameter values, preferably to determine said binned or said cumulative distributions.

In this particular embodiment a range of the parameter values is studied. After this a maximum value of the parameter value is selected as a weighting factor for normalizing the PET images. As a result next to determining the heterogeneity of the tracer uptake, the images prior to and post the event are linked and normalized with respect to the maximum uptake value. This feature enables a further insight into uptake dynamics.

In a further embodiment of the data processing system according to the invention
processing means is arranged for determining a maximum volume of the target region over said prior to and post event images;
the data processing system further comprising registration Means for registering individual target regions corresponding to individual PET images from said prior to and post images with the maximum region volume yielding registered regions;
the computing means being further arranged to:
   i. calculate weighted partial volumes with respect to the maximal volume of the target region;
   ii. determine a distribution of said weighted partial volumes over said weighted parameter values, preferably for determining said binned or said cumulative distributions.

In this particular embodiment response dynamics with respect to three characteristics may be analyzed. First, a change in a heterogeneity pattern may be studied by analyzing respective slopes of constructed distributions. Secondly, dynamics with respect to the total volume of the target region may be analyzed by analyzing respective ranges of constructed distributions along the ordinate axis. Thirdly, dynamics in the tracer uptake may be studied by analyzing respective ranges of the constructed distributions along the abscissa axis.

In a further embodiment of the data processing system according to the invention, the data processing system further comprises a display for displaying suitable distribution or distributions, as is discussed with reference to the foregoing.

In accordance to this feature a simple yet reliable feed-back is provided regarding heterogeneous response of the target regions with respect to the tracer uptake. It is possible to provide a plurality of computed distributions, for example, one after each treatment session. A suitable medical specialist may then accurately analyze a trend regarding the response of the target region to the treatment and, when appropriate to abort or to modify the treatment.

In a still further embodiment of the data processing system according to the invention wherein the image processing means is further arranged to store respective coordinates of said partial volumes, said computing means being further arranged to code the respective partial volumes in accordance with respective parameter values corresponding to said partial volumes.

It is found to be particularly advantageous not only to determine a degree of heterogeneity of the tracer uptake, but also to determine a spatial distribution of said heterogeneity. By storing the coordinates or any other suitable position information of the partial volumes having substantially the same tracer uptake it is possible to visualize this information by means of a suitable 2D or 3D display to the user. In particular, when the patient is imaged using several modalities, it is preferable to fuse image data from these one or more modalities with PET image data and to display suitably color coded partial volumes, superposed on image data of other modalities, for example on image data of CT or MRI. In this way a medical specialist is able not only to accurately assess which volumes of the target region have acquired specific tracer dose, but also to correlate these volumes with anatomical data from CT or MRI images. In this way it is possible to further improve accuracy and reliability of data assessment and to adequately substantiate further medical steps.

An arrangement according to the invention comprises a data processing system as is described in the foregoing and a further imaging device for providing further images conceived to be used for determining said target region.

Preferably, the arrangement according to the invention comprises CT and/or MRI apparatus. More preferably, image data from CT or MRI apparatus is used not only to suitably delineate the target region, but also to be fused with the PET data for providing cumulative image comprising color-coded partial volumes at least partially overlaid on the CT—and/or MRI data.

These and other aspects of the invention will be further discussed with reference to drawings, wherein like reference signs represent like elements. It will be appreciated that the presented drawings are used for illustrative purposes and may not be construed to limit the scope of the appended claims.

### BRIEF DESCRIPTION OF THE DRAWINGS

FIG. 1 presents a schematic view of an embodiment of a data processing system according to the invention;

FIG. 2 presents a schematic view of a further embodiment of a data processing system according to the invention;

FIG. 3 presents a schematic view of an embodiment of a partial volume distribution as a function of standardized uptake value, SUV.

FIG. 4 presents schematically a comparison between non-corrected and PVE-corrected cumulative distributions (i.e. cumulative SUV volume histograms).

### DETAILED DESCRIPTION OF THE DRAWINGS

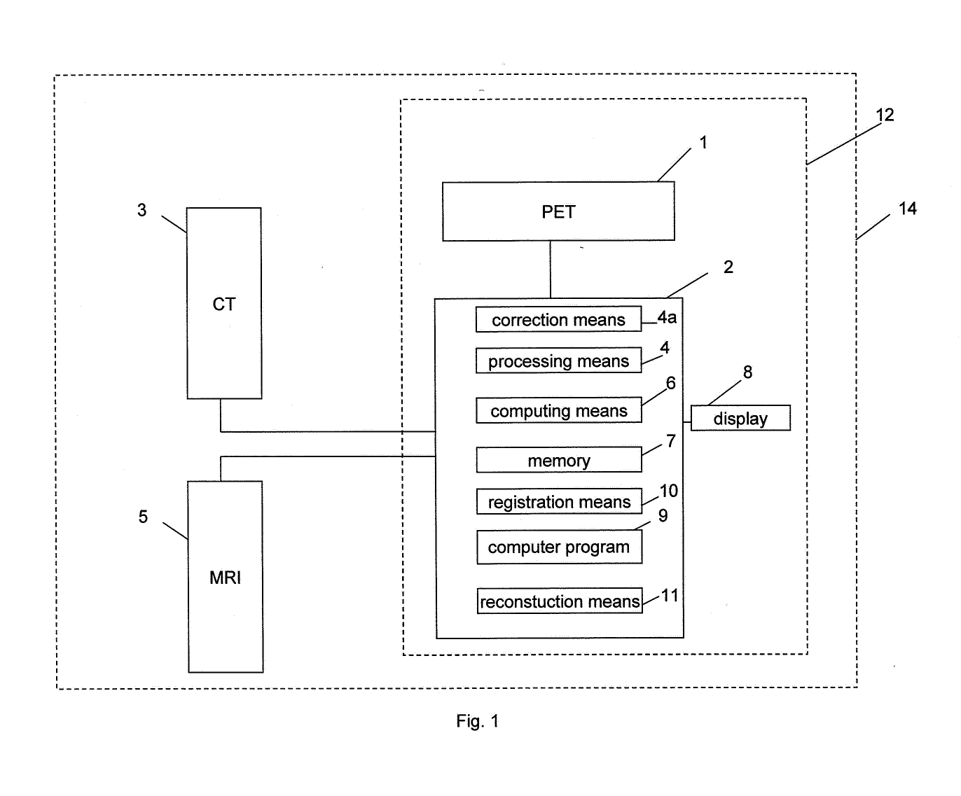

FIG. 1 presents a schematic view of an embodiment of a data processing system according to the invention. The data processing system 2 comprises image processing means 4 arranged for scoring partial volumes of the target region from one or more PET images comprising a suitable target region as a function of parameter values representative of a tracer uptake in said partial volumes. For example, in case when the parameter relates to standardized uptake value, represented by a pixel or voxel intensity in a PET image, the partial volumes may be scored in accordance with said pixel or voxel intensity. Preferably, the data processing system 2 is connected to a PET scanner 1, or forms part thereof. The data processing system 2 further comprises computing means 6 arranged for determining a distribution of said partial volumes over said parameter values. For this purpose, first, the computing means may be arranged to determine a range of the parameter values. Secondly, the computing means may be arranged to compute relative (percentage) parameter values with respect to the maximum parameter value identified in the range. Thirdly, the computing means may be arranged to relate the partial volumes having substantially the same parameter value or relative parameter value with said parameter values. Preferably, such relation is stored in a memory unit 7 as a cumulative or binned histogram.

Preferably, the data processing means 2 is further arranged to automatically locate all scans of a person under consideration and to process them together. In this respect, as has been described in the foregoing, such scans may relate to scan prior to and post some treatment procedures. The resulting histograms are preferably computed by applying suitable mutual weighting, as is described above.

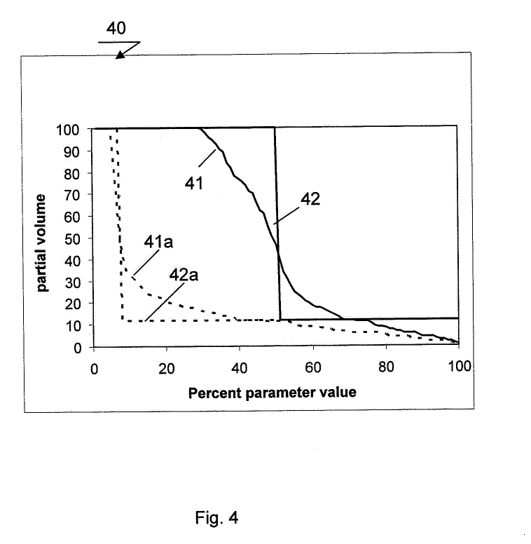

More preferably, the computing means 6 is arranged to store respective coordinates or other suitable position information of said partial volumes for purposes of presenting a 2D or 3D map giving insight on spatial distribution of partial volumes having substantially the same parameter values. This embodiment will be discussed in further detail with reference to FIG. 4. It is possible that the range of the parameter values is set to coarser sub-ranges for such mapping in comparison to sub-ranges selected for constructing the histograms.

The data processing system 2 may further comprise a display unit 8 arranged to display said histograms and/or spatial mapping of the partial volumes having substantially the same parameter value. Preferably, in order to accurately delineate a region of interest corresponding to a target region wherein the tracer element is expected to be accumulated, the PET images as registered and/or fused with diagnostic images originating from further imaging modalities. CT 3 and MRI 5 apparatus present a suitable example of such further imaging unit. In order to enable such registration the data processing system 2 preferably comprises registration means 10. The registration means 10 may be arranged to segment suitable common region of interests on available image data originating from different imaging modalities and to compute spatial transformation between said segmented common ROIs for spatial matching thereof. A plurality of per se known computational algorithms may be used for this purpose. Preferably, the computing means codes the partial volumes is accordance with a parameter value. Such coded partial volumes may be then made available to a suitable image reconstruction algorithm 11 arranged to compute a specific 2D or 3D view of such coded partial volumes. Although for coding purposes grey values may be used, color coding is preferable. The coded reconstructed 2D or 3D views of the partial volumes may then be displayed on the display 8.

Preferably, the data processing system 2 form part of an arrangement 12 further comprising a PET scanner 1. More preferably, the data processing system 2 forms part of an arrangement 14 comprising the PET scanner and a further imaging apparatus, like CT apparatus 3 and/or MRI apparatus 5. Due to multi-modality imaging accuracy of assessing heterogeneity of the tracer uptake in a target region is improved.

The data processing system may further comprise a computer program product 9 arranged to comprise instructions to a processor for carrying out a method for determining a distribution of a tracer in a target region. For example, the computer program product 9 may comprise instructions for scoring partial volumes of the target region from one or more PET images comprising the target region as a function of parameter values representative of a tracer uptake in said partial volumes and for determining a distribution of said partial volumes over said parameter values.

In addition, the computer program product 9 may comprise one or more instructions for causing a processor to carry out correcting the one or more PET images for partial volume effects of a PET scanner, wherein, in particular, a prior knowledge about properties of the PET detector and/or PET scanner or radiotracer (range of positron in tissue) is used for said correction. Examples of suitable PVE correction methods are described in the foregoing.

The computer program product 9 may further comprise one or more instructions for causing a processor to carry out the step of storing respective coordinates of said partial volumes and for coding the respective partial volumes in accordance with respective parameter values corresponding to said partial volumes. In particular, said stored coordinates may be used by the computer program product to cause a processor to reconstruct a suitable view, like a 2D or a 3D view of the partial volumes, wherein the partial volumes are suitable coded in accordance with the corresponding value of the parameter.

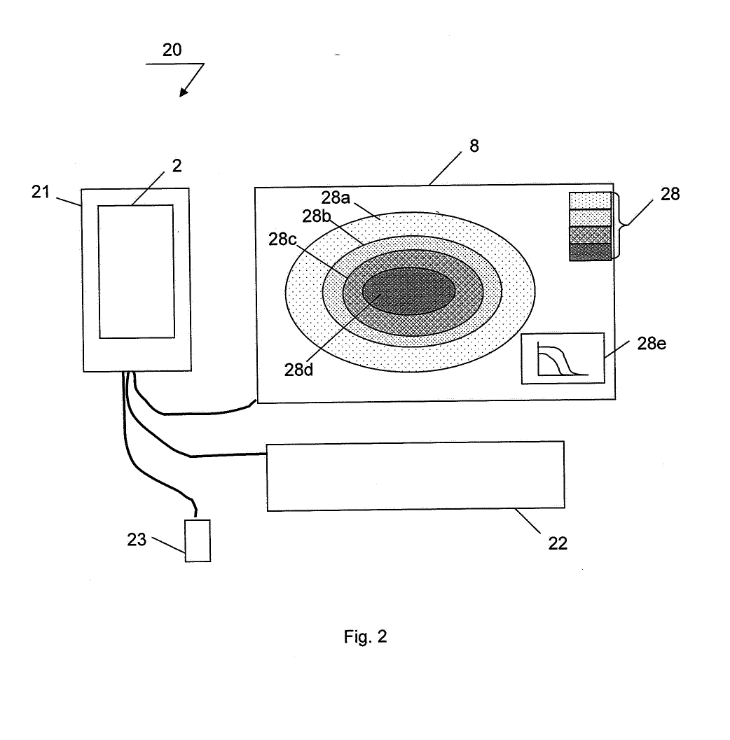

FIG. 2 presents a schematic view of a further embodiment of a data processing system according to the invention. The data processing system 2 may form part of a system 21 based on a suitable computer 21 arranged with a display unit 8, input/output devices 23, 22. The display 8 presents an embodiment of a display mode wherein coded partial volumes are presented as a 2D view. It will be appreciated that although in this example well delineated quasi-concentric regions are shown, in practice a more complicated pattern may arise. For simplicity reasons, the quasi-concentric regions 28a, 28b, 28c, 28d represent different partial volumes having specific parameter value, or a specific range of parameter values. The partial volumes 28a, 28b, 28c, 28d may be gray scale or color coded with a legend 28 being also presented. Preferably, the partial regions 28a, 28b, 28c, 28d are visualized as color coded regions.

Additionally, or alternatively the display 8 may be arranged to display the computed histograms 28e, as is discussed with reference to the foregoing. In a particular embodiment of a user interface, it may be possible to suitably toggle between different mapping, like 2D, 3D, or between different reconstruction planes, like coronal, saggital, frontal and/or between different histogram modes, like cumulative, binned, weighted cumulative, etc. It will be appreciated that a great variety of modifications of the named embodiments are possible without departing from the scope of the invention.

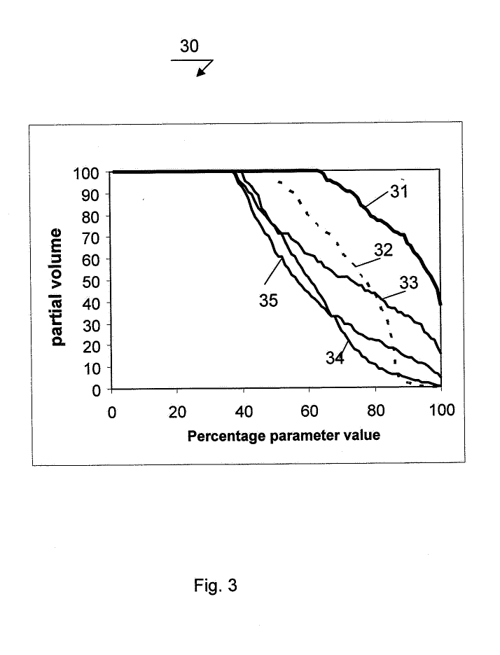

FIG. 3 presents a schematic view of an embodiment of a partial volume distribution as a function of SUV. In this exemplary embodiment of a cumulative histogram 30 four curves 31, 32, 33, 34 are shown, said curves corresponding to different events. Curve 31 corresponds to an initial condition of a target region, for example, a malignant tumor. Curve 31 represents a cumulative partial volume histogram as a function of SUV. It is seen, the 100% of the partial volume has at least 60% of the SUV value and that only 40% of the partial volume has 100% of the SUV, which represents a direct measure of heterogeneous uptake of the target region. Curve 32 has been acquired after a certain therapy, for example after several chemotherapeutic courses. It is seen, that the resulting curve 32 is different from the initial curve 31, for example in that 100% of the volume of the target region has about 50% of the maximum uptake and that a maximum uptake is about 90% of the original value. Also, in order to determine a total uptake an area under respected curves can be computed. Both the degree of heterogeneity and the area under the curve may be used to assess tumor response to chemotherapy. Further curves 33, 34, 35 are taken after respective further chemotherapeutic sessions, which show that a condition of a tumor has not substantially changed after the curve 32 has been acquired. This information is of importance to a medical specialist for deciding whether to abort, or whether to continue the present treatment. Additionally a decision about intensification of the treatment can be made and/or about selecting an adjuvant treatment.

FIG. 4 presents schematically a comparison 40 between non-corrected and PVE-corrected cumulative distributions. In this embodiment, the curves 42 and 42a are computed using PVE correction method, whereas the curves 41, 41a are computed without applying any correction for the partial volume effect. In both cases the target region had substantially non-uniform uptake. It is seen that when the resolution of the detector of a PET scanner has been eliminated from the image data, the cumulative distribution represents an expected sharp edge corresponding to an interface between the target region and the background. Curve 42 has been acquired prior to treatment and curve 42a has been acquired for the same target region post treatment. It is seen that the treatment has been successful due to a substantial reduction in the uptake. Curve 41 has been calculated for the same target region prior to treatment without applying the PVE correction. It is seen that instead of a sharp edge, as is shown in curve 42, a smooth reduction of the partial volume with SUV is seen. This smooth reduction is in fact a convolution between a sharp edge and the PET scanner resolution. It is thus clearly shown that by carrying out the PVE correction of the PET data, any noise in the data pertaining to PET scanner and/or PET detector characteristics is eliminated. Also curve 41a shows partial volume histogram as a function of SUV post treatment. Also in this case it is seen that the tracer uptake has reduced dramatically, the curve still having a smooth edge. Therefore, it is found to be advantageous to carry out PVE correction, especially for cumulative histograms, in order to eliminate noise in the PET data related to PET scanner and PET detector resolution. However, it will be appreciated that in order to study a degree of heterogeneity in a target region, it may by sufficient to calculate cumulative or binned histograms without any correction. Benefit from applying a suitable PVE correction can be seen in particularly when accurately studying percentages of partial volumes having at least a specific tracer uptake and/or for enabling accurate spatial mapping of the partial volumes.

While specific embodiments have been described above, it will be appreciated that the invention may be practiced otherwise than as described. The descriptions above are intended to be illustrative, not limiting. Thus, it will be apparent to one skilled in the art that modifications may be made to the invention as described in the foregoing without departing from the scope of the claims set out below.

1. A data processing system for determining a distribution of a tracer in a target region, said system comprising:
image processing means for scoring partial volumes of the target region from one or more PET images comprising the target region as a function of parameter values representative of a tracer uptake in said partial volumes;
computing means for determining a distribution of said partial volumes over said parameter values.

2. A data processing system according to claim 1, wherein the computer means is arranged for determining a cumulative or a binned distribution of said partial volumes over said parameter values.

3. A data processing system according to claim 1, further comprising:
correction means for correcting the one or more PET images for partial volume effects of a PET detector.

4. A data processing system according to claim 3, wherein the correction means is arranged to use a prior knowledge about properties of the PET detector for said correction.

5. A data processing system according to claim 1, wherein the one or more PET images comprise images acquired prior to and post a specified event.

6. A data processing system according to claim 5, wherein
the processing means is arranged to determine a maximum volume of the target region over said prior to and post event images;
the data processing system further comprising registration means for registering individual target regions corresponding to individual PET images from said prior to and post images with the maximum region volume yielding registered regions;
the computing means being further arranged to:
i. calculate weighted partial volumes with respect to the maximal volume of the target region;
ii. determine a distribution of said weighted partial volumes over said parameter values, preferably for determining said binned or said cumulative distributions.

7. A data processing system according to claim 5, wherein the computing means is arranged to:
determine a maximum parameter value for all images;
calculate weighted threshold parameter values with respect to the maximum parameter value;
determine a distribution of said partial volumes over said weighted threshold parameter values, preferably to determine said binned or said cumulative distributions.

8. A data processing system according to claim 7, wherein:
processing means is arranged for determining a maximum volume of the target region over said prior to and post event images;
the data processing system further comprising registration means for registering individual target regions corresponding to individual PET images from said prior to and post images with the maximum region volume yielding registered regions;
the computing means being further arranged to:
i. calculate weighted partial volumes with respect to the maximal volume of the target region;
ii. determine a distribution of said weighted partial volumes over said weighted parameter values, preferably for determining said binned or said cumulative distributions.

9. A data processing system according to claim 1, wherein the image processing means is further arranged to store respective coordinates of said partial volumes, said computing means being further arranged to code the respective partial volumes in accordance with respective parameter values corresponding to said partial volumes.

10. A data processing system according to claim 1, further comprising a display means arranged to display said distribution or said distributions.

11. A data processing system according to claim 10, the display being further arranged to display 2D or 3D color coded partial volumes.

12. A data processing system according to claim 1, wherein for the parameter a standardized uptake is selected.

13. An arrangement comprising a data processing system according to claim 1 and a PET scanner.

14. An arrangement according to claim 13, comprising a further imaging device for providing further images conceived to be used for determining said target region.

15. An arrangement according to claim 14, wherein the display means is arranged to display 2D or 3D color coded partial volumes at least partially superposed on images provided by said further imaging device.

16. A method for analyzing a distribution of a tracer in a target region, comprising:
scoring partial volumes of the target region from one or more PET images comprising the target region as a function of parameter values representative of a tracer uptake in said partial volumes;
determining a distribution of said partial volumes over said parameter values.

17. A method according to claim 16, further comprising:
correcting the one or more PET images for partial volume effects of a PET detector.

18. A method according to claim 17, further comprising using a prior knowledge about properties of the PET detector for said correction.

19. A method according to claim 16, wherein for the parameter a standardized uptake is selected.

20. A method according to claim 1, further comprising the steps of:
storing respective coordinates of said partial volumes;
coding the respective partial volumes in accordance with respective parameter values corresponding to said partial volumes.

21. A method according to claim 20, further comprising displaying said distribution and/or 2D or 3D color-coded partial volumes.

22. A computer program product comprising instructions for causing a processor to carry out the steps of the method according to claim 16.
